(19) United States
(12) Patent Application Publication
(10) Pub. No.: US 2022/0186764 A1
(43) Pub. Date: Jun. 16, 2022

(54) FIXING FRAME

(71) Applicant: Primax Electronics Ltd., Taipei (TW)

(72) Inventor: Rong-Fu Lee, Taipei (TW)

(21) Appl. No.: 17/165,659

(22) Filed: Feb. 2, 2021

(30) Foreign Application Priority Data
Dec. 11, 2020 (TW) 109143834

(51) Int. Cl. F16B 21/02

(52) U.S. Cl. CPC F16B 21/02

(57) ABSTRACT

A fixing frame includes a base body and a turntable mechanism. The base body includes an annular wall, an accommodation structure and a push button. The accommodation structure has a first opening, a second opening and a third opening. The push button includes a pin, a pressing post, a positioning post, a retaining plate and a spring. The pin is penetrated through the first opening. The pressing post is penetrated through the second opening. The positioning post is penetrated through the third opening. The turntable mechanism includes plural fourth openings. When the pressing post is not depressed, the pin is inserted into one of the plural fourth opening, so that the turntable mechanism is fixed on the base body. After the pressing post is depressed and the pin is detached from the fourth opening, the turntable mechanism is rotatable relative to the base body.

### FIELD OF THE INVENTION

The present invention relates to a fixing frame, and more particularly to a fixing frame for allowing two objects to be rotated relative to each other.

### BACKGROUND OF THE INVENTION

Generally, the backside of an electronic product such as a monitor or an all-in-one computer host (AIO PC) is equipped with an electronic device (e.g., a set-top box, a multi-functional docking station, a mini host or a minicomputer) for inputting signals, outputting signals or expanding the original functionality. Conventionally, the electronic product and the electronic device are fixed on each other in a direct locking manner or through a locking piece. However, the electronic device (e.g., the set-top box, the multi-functional docking station, the mini host or the minicomputer) has many cords or connecting ports, and the electronic device is usually maintained at a fixed angle after installation. If the angel of the electronic device is not dynamically adjustable, the electronic device is not user-friendly.

### SUMMARY OF THE INVENTION

The present invention provides a fixing frame. The fixing frame is installed between two objects. The two objects can be connected with each other through the fixing frame. In addition, the two objects can be rotated relative to each other through the fixing frame in response to the simple operation of the user. Consequently, the fixing frame can meet the user's requirements.

In accordance with an aspect of the present invention, a fixing frame is provided. The fixing frame is installed between a first object and a second object. The first object and the second object are rotatable relative to each other through the fixing frame. The fixing frame includes a base body and a turntable mechanism. The base body is fixed on the first object, and includes an annular wall, an accommodation structure and a push button. The base body is divided into an inner space and an outer space by the annular wall. The accommodation structure has a first lateral wall and a second lateral wall. The first lateral wall and the second lateral wall are opposed to each other. The first lateral wall is a part of the annular wall. The first lateral wall has a first opening and a second opening. The second lateral wall has a third opening. The push button includes a pin, a pressing post, a positioning post, a retaining plate and a spring. The retaining plate has a first surface and a second surface. The first surface and the second surface are opposed to each other. The pin is protruded externally from the first surface and penetrated through the first opening. The pressing post is protruded externally from the first surface and penetrated through the second opening. The positioning post is protruded externally from the second surface and penetrated through the third opening. The spring is sheathed around the positioning post and arranged between the second surface and the second lateral wall. The turntable mechanism is fixed on the second object. The turntable mechanism includes a circular disc and a ring-shaped rim. The ring-shaped rim is perpendicular to the circular disc and extended in a direction toward the base body. The ring-shaped rim is sheathed around the annular wall. The ring-shaped rim includes plural fourth openings. When the pressing post is not depressed, the pin is inserted into one of the plural fourth openings, so that the turntable mechanism is fixed on the base body and not rotated relative to the base body. After the pressing post is depressed and the pin is detached from the fourth opening, the turntable mechanism is rotatable relative to the base body.

In an embodiment, the base body further includes a stopping wall, and the stopping wall is arranged around the annular wall. An annual groove is formed between the stopping wall and the annular wall. The ring-shaped rim is placed into the annual groove.

In an embodiment, the fixing frame further includes a latching element, and the latching element is fixed on the circular disc and installed along a direction from the circular disc to the base body. The base body further includes a fifth opening in the inner space. A profile of the fifth opening matches a profile of the latching element. The latching element is penetrated through the fifth opening.

In an embodiment, a portion of the pin protruded externally from the first surface has a first length, and a portion of the pressing post protruded externally from the first surface has a second length. The first length is smaller than the second length.

In an embodiment, the first opening and the second opening are in communication with each other in the first lateral wall.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a fixing frame according to an embodiment of the present invention;

FIG. 1B is a schematic exploded view illustrating the fixing frame according to the embodiment of the present invention;

FIG. 1C is a schematic perspective view illustrating a push button of the fixing frame according to the embodiment of the present invention;

FIG. 2 is a schematic exploded view illustrating the relationship between the fixing frame, the first object and the second object according to the embodiment of the present invention;

FIG. 3A is a schematic cross-sectional view illustrating the fixing frame as shown in FIG. 1 and taken along the line 3A-3A;

FIG. 3B is a schematic cross-sectional view illustrating the fixing frame as shown in FIG. 1, in which the pressing post is depressed and the pin is detached from the fourth opening; and

FIG. 3C is a schematic cross-sectional view illustrating the detachment of the turntable mechanism of the fixing frame from the base body.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

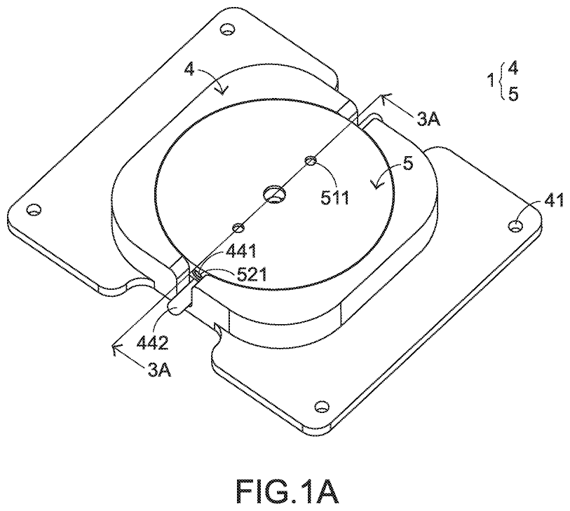

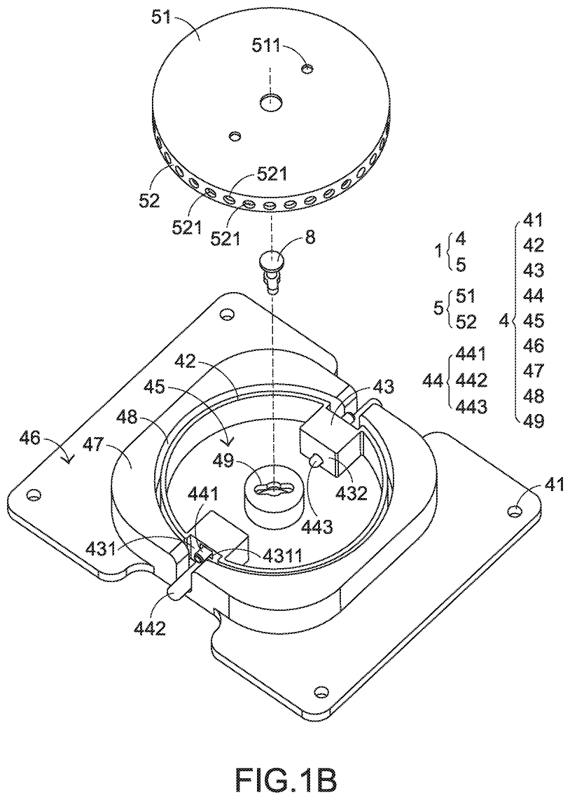

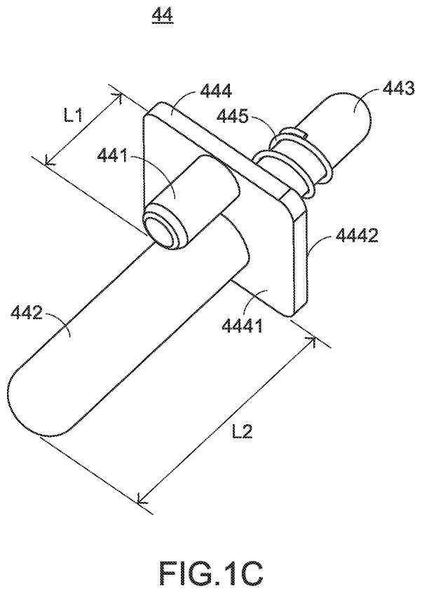

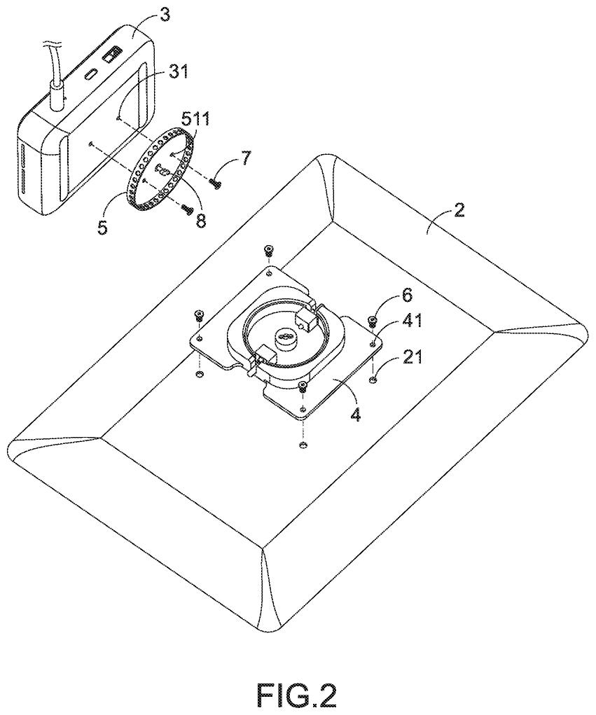

Please refer to FIGS. 1A, 1B, 1C, 2, 3A, 3B and 3C. The present invention provides a fixing frame 1. When the fixing frame 1 is installed between a first object 2 and a second object 3, the first object 2 and the second object 3 are connected with each other, and the first object 2 and the second object 3 are rotatable relative to each other.

In an embodiment, the fixing frame 1 comprises a base body 4 and a turntable mechanism 5. The base body 4 can be fixed on the first object 2. For example, the base body 4 has a fixing hole 41, and the first object 2 has a screw hole 21. After a screw 6 is penetrated through the fixing hole 41 and tightened into the screw hole 21, the base body 4 is fixed on the first object 2. It is noted that the way of fixing the base body 4 on the first object 2 is not restricted. That is, the base body 4 can be fixed on the first object 2 through any other appropriate fixing manner.

The base body 4 comprises an annular wall 42, an accommodation structure 43 and a push button 44.

Preferably but not exclusively, the annular wall 42 is a wall structure with a ring-shaped appearance or in a ring-shaped arrangement. The wall structure is an integral wall or comprises plural walls in a ring-shaped arrangement. That is, the structure and profile of the annular wall 42 are not restricted. The base body 4 is divided into an inner space 45 and an outer space 46 by the annular wall 42.

The accommodation structure 43 has a first lateral wall 431 and a second lateral wall 432. The first lateral wall 431 and the second lateral wall 432 are opposed to each other. The first lateral wall 431 is a part of the annular wall 42. The first lateral wall 431 has a first opening 4311 and a second opening 4312. In an embodiment, the first opening 4311 and the second opening 4312 are in communication with each other in the first lateral wall 431. Alternatively, the first opening 4311 and the second opening 4312 are integrally formed as a larger opening. The second lateral wall 432 has a third opening 4321.

The push button 44 comprises a pin 441, a pressing post 442, a positioning post 443, a retaining plate 444 and a spring 445. The retaining plate 444 has a first surface 4441 and a second surface 4442, which are opposed to each other. The pin 441 is protruded externally from the first surface 4441 of the retaining plate 444 and penetrated through the first opening 4311. The pressing post 442 is protruded externally from the first surface 4441 of the retaining plate 444 and penetrated through the second opening 4312. The portion of the pin 441 that is protruded externally from the first surface 4441 of the retaining plate 444 has a first length L1. The portion of the pressing post 442 that is protruded externally from the first surface 4441 of the retaining plate 444 has a second length L2. The first length L1 is smaller than the second length L2. The positioning post 443 is externally protruded from the second surface 4442 of the retaining plate 444 and penetrated through the third opening 4321. The spring 445 is sheathed around the positioning post 443 and arranged between the second surface 4442 of the retaining plate 444 and the second lateral wall 432.

The turntable mechanism 5 comprises a circular disc 51 and a ring-shaped rim 52. The turntable mechanism 5 can be fixed on the second object 3. For example, the circular disc 51 has a fixing hole 511, and the second object 3 has a screw hole 31. After a screw 7 is penetrated through the fixing hole 511 and tightened into the screw hole 31, the turntable mechanism 5 is fixed on the second object 3. The ring-shaped rim 52 is perpendicular to the circular disc 51 and extended in the direction toward the base body 4. The ring-shaped rim 52 is sheathed around the annular wall 42. Moreover, the ring-shaped rim 52 comprises plural fourth openings 521.

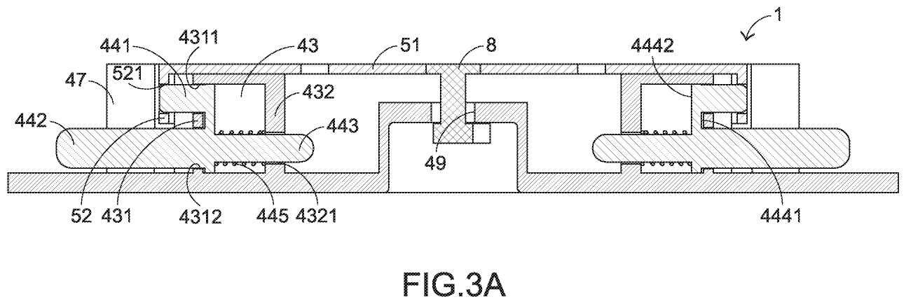

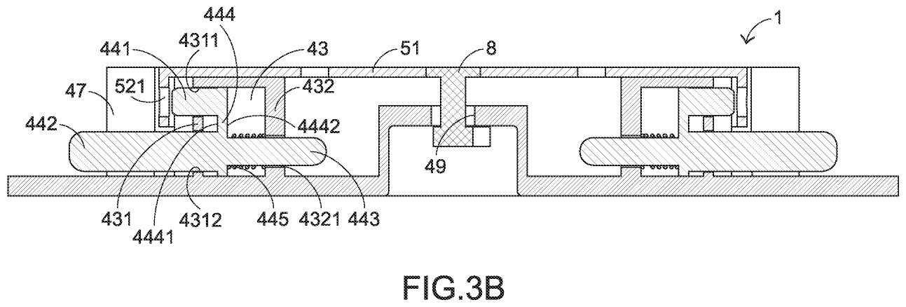

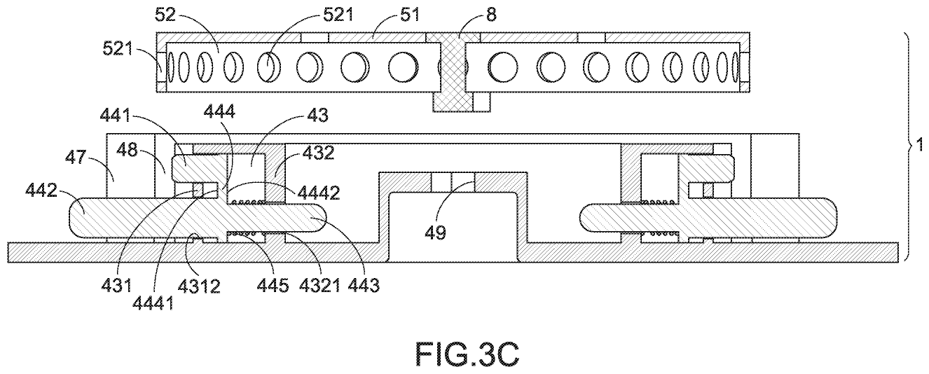

As shown in FIG. 3A, the pressing post 442 is not depressed. Meanwhile, the pin 441 is inserted into one of the fourth opening 521. Consequently, the turntable mechanism 5 is fixed on the base body 4 and unable to be rotated relative to the base body 4.

As shown in FIG. 3B, the pressing post 442 is depressed and moved in the direction from the outer space 46 to the inner space 45 for a certain distance. Meanwhile, the pin 441 is detached from the fourth opening 521. Consequently, the turntable mechanism 5 can be rotated relative to the base body 4. As the turntable mechanism 5 and the second object 3 are rotated at a certain angle, the pressing post 442 is no longer depressed. Then, the pin 441 is inserted into another fourth opening 521. Consequently, the turntable mechanism 5 and the base body 4 are fixedly connected with and unable to be rotated relative to each other. Of course, with the assistance of the fixing frame 1, the second object 3 and the first object 2 are fixedly connected with and unable to be rotated relative to each other.

For the unloading purpose, the maintenance purpose or any other possible purpose, the turntable mechanism 5 (connected with the second object 3) and the base body 4 (connected with the first object 2) need to be detached from each other. As shown in FIG. 3C, the pressing post 442 is firstly depressed and thus the pin 441 is detached from the fourth opening 521. Then, the turntable mechanism 5 is removed in the direction away from the base body 4.

As mentioned above, the first object 2 and the second object 3 can be connected with each other through the fixing frame 1. In addition, the first object 2 and the second object 3 are rotatable relative to each other through the fixing frame 1. In case that the second object 3 is an electronic device connected with a cord or a connecting port, the angle of the second object 3 with respect to the first object 2 is adjustable through the fixing frame 1. After the second object 3 is rotated at the proper angle and fixed, the cord can be plugged or removed more easily, or a connecting terminal, a card (e.g., a memory card) or any other appropriate component can be inserted into the connecting port more easily.

Please refer to FIG. 1B and FIG. 3C. The base body 4 further comprises a stopping wall 47. The stopping wall 47 is arranged around the annular wall 42. In addition, an annual groove 48 is formed between the stopping wall 47 and the annular wall 42. The ring-shaped rim 52 can be placed into the annual groove 48. Since a greater portion of the turntable mechanism 5 is sheltered, a protecting function is provided, and the appearance is more aesthetically-pleasing.

For avoiding the detachment of the turntable mechanism 5 from the base body 4 during the relative rotation, the fixing frame 1 further comprises a latching element 8. The latching element 8 is fixed on the circular disc 51 and installed along the direction from the circular disc 51 to the base body 4. The base body 4 further comprises a fifth opening 49 in the inner space 45. The profile of the fifth opening 49 matches the profile of the latching element 8. After the latching element 8 is penetrated through the fifth opening 49 and the latching element 8 is rotated at a certain angle with the turntable mechanism 5, the latching element 8 is locked in the fifth opening 49. Consequently, the base body 4 and the turntable mechanism 5 are not detached from each other.

Preferably but not exclusively, the first object is a monitor, an all-in-one computer host (AIO PC) or any other appropriate electronic product, and the second object is a set-top box, a multi-functional docking station, a mini host, a minicomputer or any other appropriate electronic device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fixing frame installed between a first object and a second object, the first object and the second object being rotatable relative to each other through the fixing frame, the fixing frame comprising:
a base body fixed on the first object, and comprising an annular wall, an accommodation structure and a push button, wherein the base body is divided into an inner space and an outer space by the annular wall, wherein the accommodation structure has a first lateral wall and a second lateral wall, the first lateral wall and the second lateral wall are opposed to each other, the first lateral wall is a part of the annular wall, the first lateral wall has a first opening and a second opening, and the second lateral wall has a third opening, wherein the push button comprises a pin, a pressing post, a positioning post, a retaining plate and a spring, the retaining plate has a first surface and a second surface, the first surface and the second surface are opposed to each other, the pin is protruded externally from the first surface and penetrated through the first opening, the pressing post is protruded externally from the first surface and penetrated through the second opening, the positioning post is protruded externally from the second surface and penetrated through the third opening, and the spring is sheathed around the positioning post and arranged between the second surface and the second lateral wall; and
a turntable mechanism fixed on the second object, and comprising a circular disc and a ring-shaped rim, wherein the ring-shaped rim is perpendicular to the circular disc and extended in a direction toward the base body, the ring-shaped rim is sheathed around the annular wall, and the ring-shaped rim comprises plural fourth openings,
wherein when the pressing post is not depressed, the pin is inserted into one of the plural fourth openings, so that the turntable mechanism is fixed on the base body and not rotated relative to the base body, wherein after the pressing post is depressed and the pin is detached from the fourth opening, the turntable mechanism is rotatable relative to the base body.

2. The fixing frame according to claim 1, wherein the base body further comprises a stopping wall, and the stopping wall is arranged around the annular wall, wherein an annual groove is formed between the stopping wall and the annular wall, and the ring-shaped rim is placed into the annual groove.

3. The fixing frame according to claim 1, wherein the fixing frame further comprises a latching element, and the latching element is fixed on the circular disc and installed along a direction from the circular disc to the base body, wherein the base body further comprises a fifth opening in the inner space, a profile of the fifth opening matches a profile of the latching element, and the latching element is penetrated through the fifth opening.

4. The fixing frame according to claim 1, wherein a portion of the pin protruded externally from the first surface has a first length, and a portion of the pressing post protruded externally from the first surface has a second length, wherein the first length is smaller than the second length.

5. The fixing frame according to claim 1, wherein the first opening and the second opening are in communication with each other in the first lateral wall.
